(19) United States
(12) Patent Application Publication
(10) Pub. No.: US 2025/0317807 A1
(43) Pub. Date: Oct. 9, 2025

(54) SYSTEMS, METHODS, AND DEVICES FOR ENHANCEMENTS BASED ON PACKET IMPORTANCE

(71) Applicant: Apple Inc., Cupertino, CA (US)

(72) Inventors: Ping-Heng KUO, London (GB); Naveen Kumar R. PALLE VENKATA, San Diego, CA (US); Ralf ROSSBACH, Munich (DE); Peng CHENG, Beijing (CN); Alexander SIROTKIN, Hod Hasharon (IL); Fangli XU, Beijing (CN); Haijing HU, Los Gatos, CA (US); Yuqin CHEN, Beijing (CN)

(21) Appl. No.: 19/171,137

(22) Filed: Apr. 4, 2025

Related U.S. Application Data
(60) Provisional application No. 63/574,872, filed on Apr. 4, 2024.

(51) Int. Cl. H04W 28/26; H04W 28/06; H04W 72/0453; H04W 72/1268; H04W 72/563

(52) U.S. Cl. CPC H04W 28/26; H04W 28/06; H04W 72/0453; H04W 72/1268; H04W 72/563

(57) ABSTRACT

Techniques are provided an uplink grant prioritized for use by one or more logical channels buffered with important protocol data unit sets. In some scenarios the uplink grant is prioritized for logical channels corresponding to data radio bearers having an activated packet set importance-based discarding mechanism. Techniques are provided for an adaptive LCP procedure that may be applied to such logical channels. Techniques are provided for scheduling requests and status reporting based upon the activated mechanism. These and many other features and examples are described.

### CROSS-REFERENCE TO RELATED APPLICATIONS

This application claims the benefit of U.S. Provisional Application No. 63/574,872, filed Apr. 4, 2024, the content of which is incorporated herein by reference in its entirety for all purposes.

### FIELD

This disclosure relates to wireless communication networks and devices.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling network nodes and access points to communicate with one another in a variety of ways. In some scenarios, UEs may communicate with multiple base stations concurrently.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example process for transmitting PDUs associated with a first level of importance using resources indicated by an uplink grant, according to one or more implementations described herein.

FIG. 2 is a diagram of an example network according to one or more implementations described herein.

FIG. 3 is a diagram of an example process for transmitting PDUs associated with a first level of importance using resources indicated by an uplink grant, according to one or more implementations described herein.

FIG. 4 is a diagram of an example process for an adaptive LCP procedure according to one or more implementations described herein.

FIG. 5 is a diagram of an example process for initiating status reporting and/or transmitting a status request according to one or more implementations described herein.

FIG. 6 is a diagram of an example process for initiating status reporting and/or transmitting a status request according to one or more implementations described herein.

FIG. 7 is a diagram of a process for transmitting PDUs associated with a first level of importance using resources indicated by an uplink grant according to one or more implementations described herein.

FIG. 8 is a diagram of a process for transmitting an uplink grant to a UE associated with a PSI-based discarding mechanism according to one or more implementations described herein.

FIG. 9 is a diagram of an example of components of a device according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE may refer to a smartphone, tablet computer, wearable wireless device, a vehicle capable of wireless communications, and/or another type of a broad range of wireless-capable device.

Telecommunication networks may include user equipment (UEs) capable of communicating with base stations and/or other network access nodes. Telecommunication networks may also include UEs and base stations communicating with a core network (CN). UEs base stations, and CNs may implement various techniques and communications standards for enabling these entities to discover one another, establish and maintain connectivity, and exchange information in an ongoing manner.

Some aspects of telecommunications may be organized and implemented according to different layers of functionality and communication, such as a packet data convergence protocol (PDCP) layer, a medium access control (MAC) layer, and/or a radio resource control (RRC) layer. The PDCP layer may include one or more functions associated with transmitting one or more packets of data, below the RRC layer. The RRC layer may include one or more functions associated with initiating connections, releasing connections, modifying connections, and/or maintaining connections between UEs and base stations (gNBs). For example, the RRC layer may configure data radio bearers to logical channels used to communicate data between the UEs and gNBs. The MAC layer may include one or more functions associated with managing access to one or more radio channels included in a network, such as managing radio communication resources and/or determining transmission timing.

Generally, the PDCP layer for a data radio bearer (DRB) may be associated with a packet discarding mechanism. For example, the PDCP layer of the DRB may be associated with one or more mechanisms to discard one or more protocol data units (PDUs) (e.g., a set of one or more internet protocol (IP) packets) from a transmit buffer of the UE. One or more PDUs may be included in a PDU set, which may be a grouping of one or more PDUs. In some examples, a PDU set carries one unit of information generated by an application, such as a frame and/or slice of a video used for extended reality (XR) services and/or applications.

In some examples, a packet discarding mechanism is based upon a level of importance associated with the one or more PDUs. For example, the application, the UE and/or the gNB may optionally determine a PDU set importance (PSI) to one or more PDU sets and/or one or more packets. Accordingly, a UE may employ a mechanism which determines whether a PDU Set is considered as important or less important. For example, assuming each PDU Set is associated with a PSI value, a first PSI value may correspond to a high level of importance associated with a first PDU set, and a second, higher PSI value may correspond to a lower level of importance associated with a second PDU set. In some examples, if the second PSI value is greater than a threshold PSI value, and if the first PSI value is lower than the threshold PSI value, the corresponding second PDU set is therefore considered a relatively less important PDU set, while the first PDU set is considered as an important PDU Set. For example, a PSI of decimal 1 would be a highest priority PDU set, and a PSI of decimal 16 would be a lowest priority PDU set.

In some examples, the UE is configured to use a value of a discard timer associated with the one or more PDU sets. The UE may start the discard timer when a packet arrives from an upper layer, and may discard the packet upon expiry of the discard timer.

In some scenarios, the UE may transmit a delay status report (DSR) to the gNB, including information reporting a remaining time before data is discarded from a transmit buffer. The DSR may be triggered when the remaining time till expiry of discard timer is less than a remaining time threshold. Additionally or alternatively, the DSR may include information relating to the volumes of data satisfying the remaining time threshold, in a transmit buffer associated with the one or more logical channel groups (LCGs) that respectively include one or more LCHs. In some examples, at the time that the UE performs one or more operations included in a logical channel prioritization (LCP) procedure, the UE may determine which—if any—LCHs have important PDU sets in the transmit buffer.

An uplink grant may include information defining the radio resources made available to the UE for uplink transmission by the gNB. For example, the gNB may determine downlink control information (DCI) for resource scheduling. As described further herein, the gNB may transmit a downlink control signal for a dynamic grant, which includes a DCI field designating that the resources specified by the dynamic grant are to be used for LCHs including important packets in the transmit buffer. As described further herein, it is understood that description of scenarios in which LCHs that may be buffered with important, or less important PDU sets are non-limiting scenarios. As additional or alternative examples, a UE may apply similar or the same logic to determining whether LCHs are buffered with important or less important packets, and may initiate procedures similar to or the same as described with reference to examples in which LCHs may be buffered with important PDU sets. The uplink grant may be a configured grant, wherein a parameter in a configured grant configuration may similarly designate that the resources specified by the configured grant are to be used for LCHs including important packets in the transmit buffer.

A data radio bearer (DRB) may be associated to one or more logical channels that carries UE data between the UE and the gNB. In some examples, the gNB determines and configures parameters associated with the DRB and the corresponding logical channels.

A logical channel prioritization (LCP) is a procedure performed by a UE to generate a transport block (TB) for uplink transmission on a resource indicated by an uplink grant. The procedure may include one or more operations based on the parameters configured for one or more logical channels such as priority, and/or determining the mapping between one or more LCHs to resources indicated by the uplink grant. For example, the UE may perform one or more LCP procedures which may include determining which—if any—LCHs are associated with important PDU sets and/or packets included in the transmit buffer. In some scenarios, the UE may perform the one or more LCP procedures described herein based upon the presence or absence of important PDU sets and/or packets that are buffered in the LCHs of the UE, in addition to or in the alternative to the presence or absence of important PDU sets and/or packets that are buffered in the transmit buffer. In some scenarios, the UE may preferentially allocate some or all of the resources specified in the uplink grant for such logical channels being buffered with PDU sets and/or packets and/or that correspond to important PDU sets and/or packets in the transmit buffer. In some scenarios, the UE may prioritize use of resources indicated by the uplink grant for transmitting important PDU sets and/or packets, and may use any resources not occupied by the important PDU sets and/or packets for PDU sets and/or packets of lesser importance (e.g., having a PSI beyond the PSI threshold).

A feedback relating to a status of transmit buffer of a UE may include one or more scheduling requests (SRs), buffer status reports (BSRs), and/or delay status report (DSRs). A scheduling request may include a request transmitted from the UE to the gNB requesting an uplink grant be sent to the UE. A BSR may include a report transmitted from the UE to the gNB requesting one or more uplink grants be sent to the UE. Additionally, the buffer status report may include information about data volumes pending in the buffer of the UE. A DSR as described above may include information indicating an amount of time until one or more packets are discarded from the transmit buffer of the UE.

In some examples, each packet may be associated to a particular importance level. For example, first one or more packets included in a PDU set may be used to decode subsequent packets and/or PDU sets at the application layer. Accordingly, the first one or more packets may be of a relatively higher importance as compared to other packets and/or PDU sets. The Application layer, therefore, may assign a PSI level that indicates that the first one or more packets are of relative importance. In some scenarios, the PDCP layer of a DRB discards less important packets and/or PDU sets and/or packets that remain buffered in one or more LCHs for a shorter period of time as compared to important packets and/or PDU Sets. Such procedures, dubbed as PSI-based discarding, may increase the likelihood that the important PDU sets and/or packets are successfully transmitted from the UE to the base station, especially when congestion is present. The mechanism of PSI-based discarding on each DRB may be dynamically activated or deactivated by the gNB.

It may be appreciated that current telecommunication solutions, however, fail to address techniques for prioritizing transmission of such important packets and/or PDU sets. Disclosed herein are multiple techniques which may improve prioritization of important packets and/or PDU sets, and/or techniques supporting integration of such techniques. For example, the techniques herein describe the use of configured or dynamic grants prioritizing the transmission of important PDU sets, the prioritization of important PDU sets and/or packets when performing a LCP, and/or the consideration of important PDU sets and/or packets when delivering a status report from a UE to a base station.

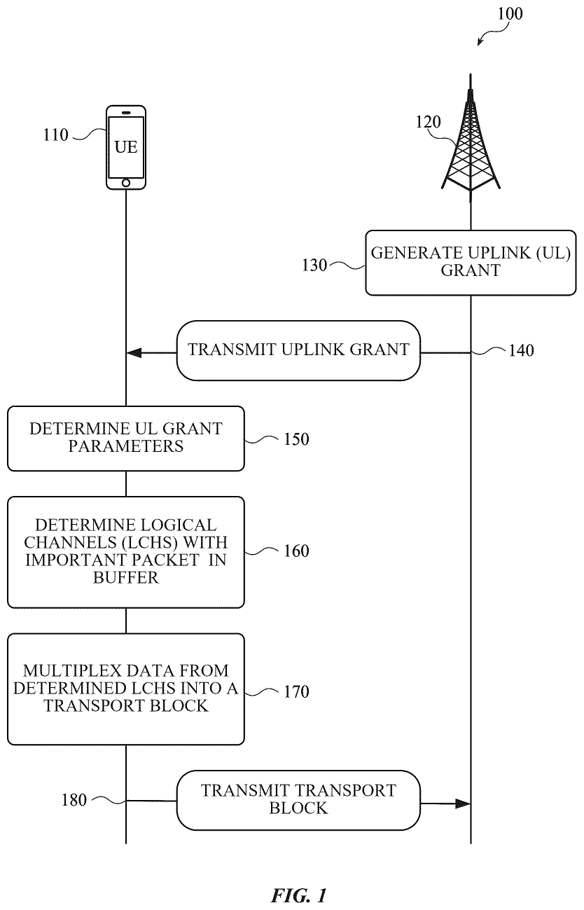

FIG. 1 is a diagram of an example of an example process 100 for transmitting PDUs associated with a first level of importance using resources indicated by an uplink grant, according to one or more implementations described herein. Process 100 may be implemented by UE 110 and base station 120.

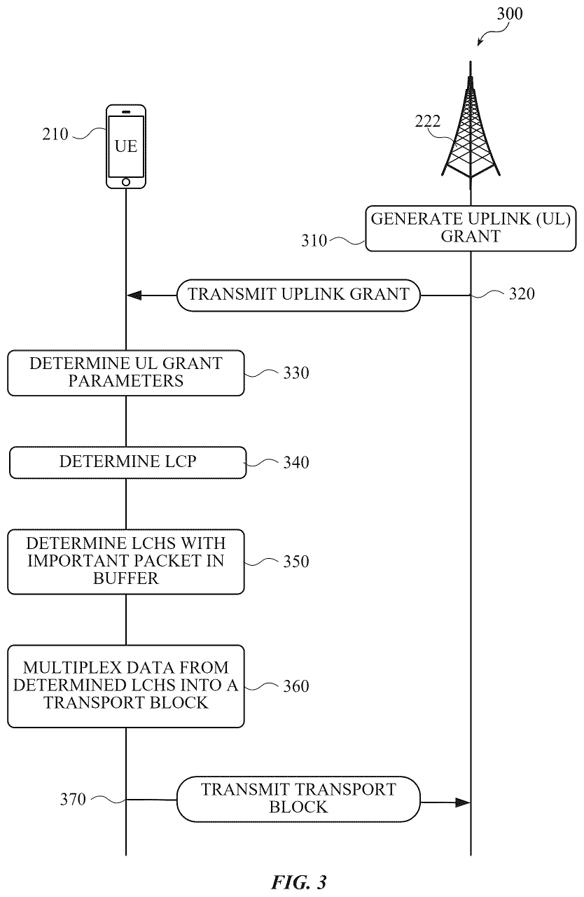

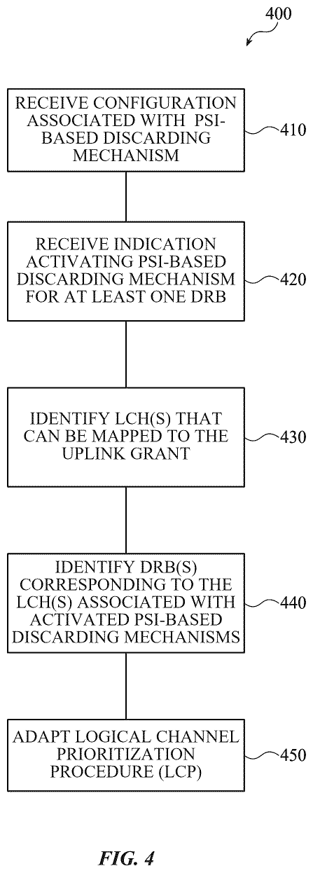

In some scenarios, base station 120 may generate an uplink grant for UE 110 (block 130). For example, the uplink (UL) grant is optionally a dynamic or configured UL grant that is configured to prioritize transmission of important PDU sets and/or packets in the transmit buffer of UE 110. For example, the UL grant specifies radio resources that are to be prioritized or exclusively used for important PDU sets and/or packets and LCHs that are buffered with important PDU sets and/or packets. As an example, when the UE 110 performs a LCP procedure as described further with reference to FIGS. 3-4, the UE 110 may exclusively allocate radio resources defined by the UL grant for logical channels that have important PDU sets and/or packets in the transmit buffer of UE 110. A transmit buffer may include memory included in UE 110 that temporarily holds one or more PDUs that may be transmitted by UE 110 to base station 120. As described further herein, the relative importance of a PDU set may include determining whether one or more packets included in the PDU set are associated with a level of importance (e.g., a PSI) that is less than or greater than a threshold level of importance in a quality of service (QoS) flow.

In some scenarios, the base station 120 may transmit the UL grant (block 140) to the UE 110. In some scenarios, in response to receiving the UL grant, the UE 110 may determine parameters associated with the UL grant (block 150). For example, the UL grant may specify one or more channel mapping restrictions (e.g., restrictions), may specify a level of importance to be associated with a logical channel that may have an important PDU set in the transmit buffer, may specify that the resources indicated by the UL grant may only be used for logical channels that have important PDU sets and/or packets in the transmit buffer, and/or some combination thereof. As described above, the UL grant may include a parameter that restricts the resources indicated by the UL grant for LCHs that have important PDU sets and/or packets in the transmit buffer. In some scenarios, the UL grant does not expressly specify such a parameter, and/or UE 110 is configured to prioritize transmission of first logical channels having important PDU sets and/or packets in the transmit buffer, but does not necessarily exclude transmission of data from second logical channels that do not have important PDU sets and/or packets in the transmit buffer.

In some scenarios, UE 110 may determine which—if any—one or more logical channels have the important PDU sets and/or packets in the transmit buffer (block 160). For example, UE 110 may determine that resources indicated by the UL grant are restricted to exclusively select and/or transmit PDU sets and/or packets that are deemed important (e.g., based on a PSI level, and/or based on additional or alternative factors), and may determine first one or more LCHs that have important PDU sets and/or packets in the transmit buffer. As described previously, in some scenarios, the UE may determine which one or more LCHs are buffered with important PDU sets and/or packets, in addition to on in the alternative to determining the presence of important PDU sets and/or packets in the transmit buffer.

In some scenarios, such as a first scenario, UE 110 additionally determines whether one or more data radio bearers (DRBs) corresponding to the first one or more LCHs are associated with an activated PSI-based discarding mechanism, as described above and herein. For example, the base station 120 may activate the PSI-based discarding mechanism for one or more DRBs using RRC signaling, such as in response to obtaining a buffer status report (BSR) from UE 110, and/or in accordance with a determination that network congestion and/or QoS requirements may necessitate the activation.

In some scenarios, such as a second scenario different from the first scenario, UE 110 selects one or more LCHs that have important PDU sets and/or packets in the transmit buffer, independently of whether corresponding one or more DRBs have the activated PSI-based discarding mechanism. Thus, in some scenarios, UE 110 selects and/or determines one or more first LCHs which may have important PDU sets and/or packets in the transmit buffer, and does not select one or more second LCHs which may not have important PDU sets and/or packets in the transmit buffer. Data from the selected LCHs may thereafter be pushed from UE 110 to base station 120 in accordance with the resources indicated by the UL grant. For example, as described further herein at least with reference to FIGS. 3-4, UE 110 may perform LCP procedures based upon priority levels associated with the one or more first LCHs, and may disregard the one or more second LCHs.

In some scenarios, UE 110 prioritizes LCHs that have important PDU sets and/or packets in the transmit buffer, but does not exclude the possibility of transmitting data from LCHs that do not have important PDU sets and/or packets in the transmit buffer using resources indicated by the UL grant. For example, the UL grant may indicate and/or be used to determine the LCHs described with reference to the first scenario and the second scenario. In accordance with the UL grant, UE 110 may assign priority level to the one or more first LCHs that is a higher than a priority level (e.g., a relatively lower PSI) than the priority level assigned to one or more second LCHs that do not have important PDU sets and/or packets in the transmit buffer. In some scenarios, when UE 110 determines that there are resources indicated by the UL grant that are not consumed by the PDUs associated with the one or more first LCHs (e.g., after reserving resources for the one or more first LCHs indicated by the UL grant), UE 110 allocates the remaining resources indicated by the UL grant for PDU sets and/or packets corresponding to the one or more second LCHs that do not have important PDU sets and/or packets in the transmit buffer.

In some scenarios, as described with reference to the first scenario, the UE 110 preferentially selects the one or more first LCHs when one or more DRBs corresponding to the one or more first LCHs are associated with an activated PSI-based discarding mechanism. For example, when the PSI-based discarding mechanism is activated for the one or more DRBs, UE 110 may prioritize the one or more first LCHs when allocating resources indicated by the UL grant to various LCHs. As another example, when the one or more DRBs are associated with de-activation of the PSI-based discarding mechanism, UE 110 may treat the one or more first LCHs without preferential treatment, allocating resources indicated by the UL grant to various LCHs independently of the presence of important PDU sets and/or packets in the transmit buffer that correspond to the one or more first LCHs.

In some scenarios, as similarly to as described with reference to the second scenario, UE 110 prioritizes the one or more first LCHs, independently of whether the one or more DRBs are associated with the activated PSI-based discarding mechanism. Thus, a first portion of a transport block (described below) may be occupied by one or more important PDU sets and/or packets corresponding to the one or more first LCHs, and a second portion of the transport block may be occupied by one or more important PDU sets and/or packets corresponding to the one or more second LCHs, such that the first portion corresponds to a relatively greater portion of the resources indicated by the UL grant as compared to the second portion.

In some scenarios, UE 110 multiplexes data from the selected and/or determined LCHs into a transport block (block 170). For example, UE 110 performs MAC layer multiplexing in accordance with the selected LCHs into a transport block. UE 110 may multiplex the data in accordance with information indicated in the UL grant, which may specify the radio resources available for the shared transport block. It is understood that any applicable techniques to multiplex the available data using the available resources (e.g., frequency division multiplexing, time division multiplexing, space division multiplexing, and/or code division multiplexing) may be employed. After preparing the transport block, UE 110 may transmit the transport block to base station 120 (block 180).

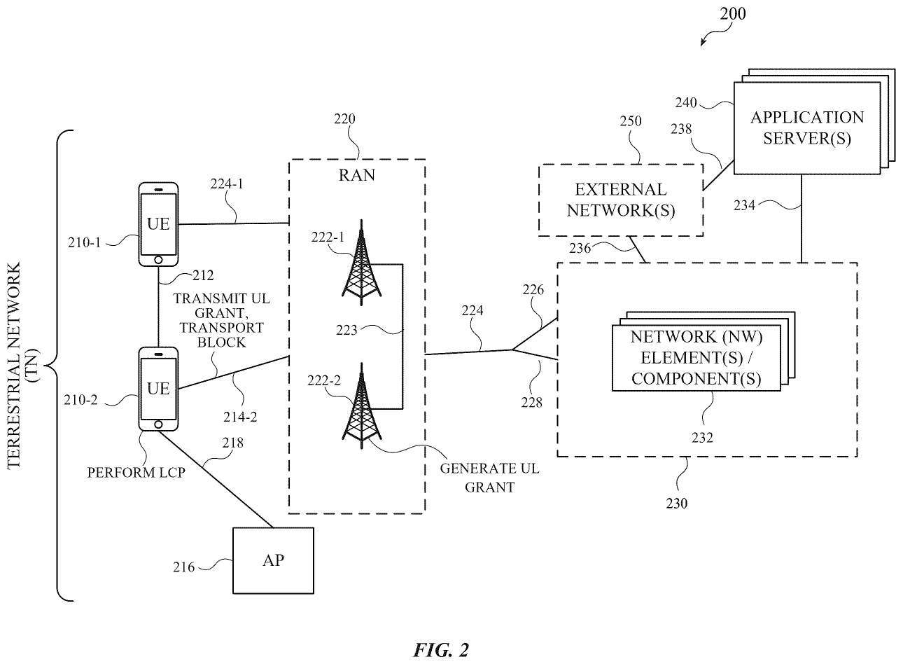

FIG. 2 is an example network 200 according to one or more implementations described herein. Example network 200 may include UEs 210-1, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210-1 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

In some scenarios, UE 210 and base station 222-2 may communicate information to define transmission in accordance with a UL grant. For example, base station 222-2 may obtain an indication and/or make a determination as to the resources that will be allocated by the UL grant, such as based on a determination of network congestion associated with RAN 220. Base station 222-2 may transmit the UL grant to UE 210-2, and in response, UE 210-2 may perform one or more LCP procedures to determine prioritization of various logical channels. For example, UE 210-2 may prioritize use of the resources defined by the UL grant to transmit PDU sets and/or packets in the transmit buffer of UE 210-2 that are important (e.g., associated with a PSI that is greater than or equal to a threshold level). Accordingly, UE 210-2 may identify such important PDU sets and/or packets, and multiplex the PDUs into a transport block. In some implementations, UE 210-2 transmits the transport block back to base station 222-2 in accordance with the UL grant.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 1, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink (UL) and downlink (DL) dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed band or spectrum may include the 5 GHz band. In an additional or alternative example, an unlicensed spectrum may include the 5 GHz unlicensed band, a 6 GHz band, a 60 GHz millimeter wave band, and more.

A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210-2 within a cell) may be performed at any of the RAN nodes 222 based on channel quality information fed back from any of UEs 210. The downlink resource assignment information may be sent on the PDCCH used for (e.g., assigned to) each of UEs 210.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 222 may be configured to communicate with one another via interface 223. In implementations where the system is an LTE system, interface 223 may be an X2 interface. In NR systems, interface 223 may be an Xn interface. In some implementations, such as a standalone (SA) implementation, interface 223 may be an Xn interface. In some implementations, such as non-standalone (NSA) implementations, interface 223 may represent an X2 interface and an XN interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 may also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

FIG. 3 is a diagram of an example process 300 for transmitting PDUs associated with a first level of importance using resources indicated by an uplink grant, according to one or more implementations described herein. Process 300 may be performed by UE 210 and/or base station 222-1 and/or 222-2 described with reference to process 300 may be implemented by UE 210 and/or base station 222-1 and/or 222-2, respectively. In some implementations, some or all of process 300 may be performed by, or in combination with, one or more other systems or devices, including one or more of the devices of FIG. 2.

Additionally, process 300 may include one or more fewer, additional, differently ordered and/or arranged operations than those shown in FIG. 3, including other processes and/or operations discussed herein. For example, process 300 may include operations preceding, performed in parallel with, and/or following one or more of the depicted operations. Furthermore, some or all the operations of process 300 may be performed independently, successively, simultaneously, etc., of one or more of the other operations of process 300. As such, the techniques described herein are not limited to a number, sequence, arrangement, timing, etc., of the operations or processes depicted in FIG. 3.

In some scenarios, base station 120 may generate an uplink grant for UE (block 310). For example, the uplink (UL) grant is optionally a dynamic or configured UL grant that is configured to prioritize transmission of important PDU sets and/or packets in the transmit buffer of UE 110. For example, the UL grant specifies radio resources that are to be prioritized or exclusively used to important PDU sets and/or packets. As an example, when the UE 110 performs a logical channel prioritization (LCP) as described further with reference to FIG. 4, the UE 110 may exclusively allocate radio resources defined by the UL grant for logical channels that have important PDU sets and/or packets in the transmit buffer of UE 110.

In some scenarios, the base station 120 may transmit the UL grant (block 320) to the UE 110. In some scenarios, in response to receiving the UL grant, the UE 110 may determine parameters associated with the UL grant (block 330). For example, the UL grant may specify one or more channel mapping restrictions (e.g., rules), may specify a level of importance to be associated with a logical channel that may have an important PDU set in the transmit buffer, may specify that the resources indicated by the UL grant may only be used for logical channels that have important PDU sets and/or packets in the transmit buffer, and/or some combination thereof. As described above, the UL grant may include a parameter that restricts the resources indicated by the UL grant for logical channels that have important PDU sets and/or packets in the transmit buffer. In some scenarios, the UL grant does not expressly specify such a parameter, and/or the UE 110 is configured to prioritize transmission of first logical channels having important PDU sets and/or packets in the transmit buffer, but not to exclude transmission of data from second logical channels that do not have important PDU sets and/or packets in the transmit buffer.

In some scenarios, UE 110 may determine a LCP (block 340). For example, the LCP as described further with reference to FIG. 4 may involve including data from logical channels in accordance with levels of priority (e.g., from a low PSI level corresponding to a relatively high priority to a high PSI level corresponding to a relatively low priority). For example, base station 120 may provide logical channel configuration information, which may include uplink specific parameters. Such parameters may include a priority level, a prioritized bit rate, a bucket duration, a number of allowed serving cells, a maximum PUSCH duration, one or more logical channel groups, one or more scheduling request IDs, boolean(s) representing a logical channel delay timer, and/or some combination thereof. In some scenarios, UE 110 performs LCP by configuring mapping restrictions (e.g., mapping rules) for one or more logical channels. For example, the LCP may include an allowed list of allowed subcarrier spacings, maximum PUSCH durations, indications allowing use of Type 1 configured grants, allowed serving cells, allowed configured grants, and/or priority indices of a dynamic grant. The UE 110 MAC sublayer may be employed to map logical channels from the RLC sublayer to transport channels in the physical (PHY) layer, multiplexing PDU sets and/or packets from the logical channels into a transport block.

In some scenarios, UE 110 may determine which—if any—one or more logical channels have the important PDU sets and/or packets in the transmit buffer (block 350). In some scenarios, the operations described with reference to block 350 are included in the LCP operations described with reference to block 340. For example, UE 110 may determine that resources indicated by the UL grant are restricted to exclusively select and/or transmit PDU sets and/or packets that are deemed important (e.g., based on a PSI level, and/or based on additional or alternative factors), and may determine first one or more LCHs that have important PDU sets and/or packets in the transmit buffer. In some scenarios, such as a first scenario, UE 110 additionally determines whether one or more data radio bearers (DRBs) corresponding to the first one or more LCHs are associated with an activated PSI-based discarding mechanism, as described above and herein. For example, the base station 120 may activate the PSI-based discarding mechanism for one or more DRBs as indicated by RRC signaling or MAC control element (MAC CE). As an example, base station 120 may activate the PSI-based discarding mechanism in response to obtaining a buffer status report from UE 110, and/or in accordance with a determination that network congestion and/or QoS requirements may necessitate the activation.

In some scenarios, such as a second scenario different from the first scenario, UE 110 selects one or more LCHs that have important PDU sets and/or packets in the transmit buffer, independently of whether corresponding one or more DRBs have the activated PSI-based discarding mechanism. Thus, in some scenarios, UE 110 selects and/or determines one or more first LCHs which may have important PDU sets and/or packets in the transmit buffer, and does not select one or more second LCHs which may not have important PDU sets and/or packets in the transmit buffer. The selected LCHs may thereafter be pushed from UE 110 to base station 120 in accordance with the resources indicated by the UL grant. For example, as described further herein, UE 110 may perform LCP operations based upon priority levels associated with the one or more first LCHs, and may forgo inclusion of PDU sets and/or packets from the one or more second LCHs in a transport block.

In some scenarios, UE 110 prioritizes LCHs that have important PDU sets and/or packets in the transmit buffer, but does not exclude the possibility of using resources indicated by the UL grant to transmit data from LCHs that do not have important PDU sets and/or packets in the transmit buffer. For example, the UL grant may indicate and/or be used to determine the LCHs described with reference to the first scenario and the second scenario, and may indicate that the priority level assigned to the one or more first LCHs is higher than a priority assigned to other one or more LCHs that do not have important PDU sets and/or packets in the transmit buffer. In some scenarios, when UE 110 determines that there are resources indicated by the UL grant that are not consumed by the PDUs associated with the one or more first LCHs, UE 110 allocates the remaining resources for the one or more second LCHs that do not have important PDU sets and/or packets in the transmit buffer.

In some scenarios, as described with reference to the first scenario, the UE 110 preferentially selects the one or more first channels when one or more DRBs corresponding to the one or more first channels are associated with an activated PSI-based discarding mechanism. For example, when the one or more DRBs are associated with the activated PSI-based discarding mechanism, UE 110 may prioritize inclusion of PDU sets and/or packets corresponding to the one or more first LCHs when allocating the resources indicated by the UL grant. As different example, when the one or more DRBs are associated with de-activation of the PSI-based discarding mechanism, UE 110 may treat the one or more first LCHs without preferential treatment, allocating resources indicated by the UL grant to various LCHs independently of the presence of important PDU sets and/or packets in the transmit buffer that correspond to the one or more first LCHs. In some scenarios, as described with reference to the second scenario, UE 110 prioritizes the one or more first LCHs, independently of whether the one or more DRBs are associated with the activated PSI-based discarding mechanism.

In some scenarios, the discard timer threshold is a first value when the PDU set is not an important PDU set and/or does not include one or more packets that are determined to be important (e.g., the corresponding PSI level(s) are greater than a threshold PSI level). In some scenarios, the discard timer threshold is a second value, which may be greater than or less than the first value, when the PDU set is an important PDU set and/or includes one or more packets that are determined to be important (e.g., the corresponding PSI level(s) are less thana or equal to the threshold PSI level). As described further herein, PSI may be employed to quantity the level of importance of packet(s) and/or PDU set(s). In some scenarios, the threshold PSI level that differentiates an “important” PDU set from a less important PDU set may be assigned in accordance with an application setting (e.g., determined by UE 110).

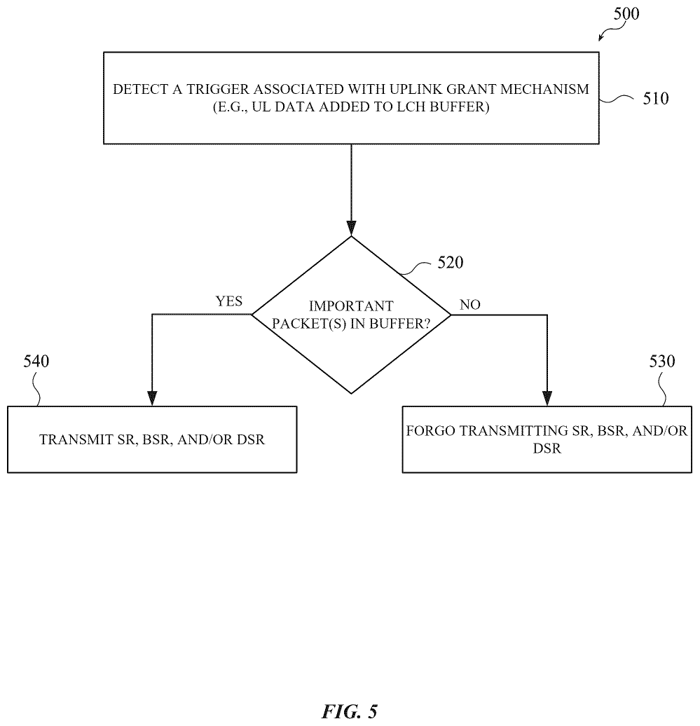

In some scenarios, when the sojourn time is within a threshold amount of time until reaching the discard timer threshold, UE 110 may transmit a delay status report (DSR). In some scenarios, the UE 110 determines delay-critical data volumes, and reports the delay-critical data volume to the base station 120. In some scenarios, the delay-critical volume is calculated in accordance with the value of the discard timer (e.g., the discard timer having the first value when the related PDU sets and/or packets are not important, or having the second value when the related PDU sets and/or packets are important). In some scenarios, UE 110 does not transmit a DSR when the related PDU sets and/or packets are not important, as described further with reference to FIG. 5. Accordingly, in response to receiving the DSR, base station 120 may determine a UL grant that prioritizes and/or optimizes transmission of important PDU sets and/or packets. The base station 120 may transmit the new UL grant in response to receiving the DSR, which UE 110 may user to prioritize important PDU sets and/or packets. It is understood that such scenarios are not limiting, and that the UL grant may indeed be flexibly used for transmitting non-important PDU sets and/or packets.

In some scenarios, UE 110 multiplexes data from the selected and/or determined LCHs into a transport block (block 360). For example, UE 110 performs MAC layer multiplexing in accordance with the selected LCHs into a shared transport block. UE 110 may multiplex the data in accordance with information indicated in the UL grant, which may specify the radio resources available for the shared transport block. It is understood that any applicable techniques to multiplex the available data using the available resources (e.g., frequency division multiplexing, time division multiplexing, space division multiplexing, and/or code division multiplexing) may be employed. After preparing the transport block, UE 110 may transmit the transport block to base station 120 (block 370).

FIG. 4 is a diagram of an example process 400 for an adaptive LCP procedure according to one or more implementations described herein. The various operations described with reference to process 400, for example, may have one or more characteristics similar to or the same as described with reference to FIGS. 1 and 3. In some scenarios, a UE may receive configuration information included in an uplink grant, and prepare for a LCP procedure in accordance with the configuration information (block 410). For example, the configuration may include designating a discard timer value (e.g., for important and/or non-important PDU sets and/or packets) for one or more DRBs associated with the UE. As an example, the base station may transmit an RRC message to the UE designating the value of the discard timer (e.g., for lower importance PDU sets and/or packets and/or for higher importance PDU sets and/or packets). In some scenarios, the UE may determine parameters included in the UL grant, such as one or more indications that PSI-based discarding mechanism(s) for one or more DRBs are activated or deactivated (block 420), such as indicated in MAC CE message transmitted from a base station to the UE. In some scenarios, the above operations may be performed prior to initiation of the LCP procedure.

In some scenarios, the UE may identify one or more LCHs that may be mapped to resource indicated by the UL grant (block 430). For example, as described with reference to FIGS. 1 and 3, the UE may determine that one or more LCHs have one or more important PDU sets and/or packets in the buffer (e.g., are buffered with important PDU sets and/or packets), that one or more DRBs corresponding to the one or more LCHs are associated with an activated PSI-based discarding mechanism, that the UL grant resources may only be used by such one or more LCHs, and/or that the UL grant resources may be used by one or more LCHs that do not have important PDU sets and/or packets in the transmit buffer using second resources remaining after reserving first resources for one or more LCHs associated with important PDU sets and/or packets. In some scenarios, the UE identifies which one or more DRBs corresponding to the identified one or more LCHs are associated with an activated PSI-based discarding mechanism (block 440). As described further herein, such an operation may inform whether PSI is a factor in determining prioritization of various LCHs. Accordingly, the UE may identify the eligible one or more LCHs that may be mapped to resources indicated by the UL grant.

In some scenarios, the UE may determine adapt the LCP procedure based upon the operations described above (block 450). In some scenarios, the LCP may be determined in accordance with operations described with reference to block 340 of FIG. 3. Additionally or alternatively, the UE may modify the parameters associated with one or more LCHs to improve the likelihood important PDU sets and/or packets are transmitted to the base station without being discarded.

In some scenarios, the UE may at least temporarily alter the configuration of one or more LCHs that do not have one or more important PDU sets and/or packets in the transmit buffer. For example, UE 110 may change (e.g., decrease) the level of priority of such one or more LCHs. As an example, the UE may assign and/or modify a level of priority associated with a LCH, different from a PSI level associated with individual PDU sets and/or packets that correspond to the LCH. The UE may raise the priority level, such that that the UE may include PDU sets and/or packets corresponding to the LCH over PDU sets and/or packets corresponding to a different LCH corresponding to a lower priority level. Additionally or alternatively, the UE may decrease the prioritized bit rate associated with the one or more LCHs, and/or may restrict the mapping of the one or more LCHs (e.g., reserving resources for LCHs including important PDU sets and/or packets). In some scenarios, the LCP includes prioritizing multiplexing data corresponding to an important PDU set that corresponds to a first LCH associated with a first priority level. In such scenarios, the LCP procedure includes prioritizing the important PDU set over another, lesser important PDU set that corresponds to a second LCH, despite the possibility that the first LCH may be associated with a second priority level (e.g., is typically determined to be “more important” of a LCH) than the first LCH.

In some scenarios, the UE may at least temporarily alter the configuration of one or more LCHs that have one or more important PDU sets and/or packets in the transmit buffer. For example, the UE may increase the level of priority of such one or more LCHs, may increase the prioritized bit rate associated with the one or more LCHs, and/or may change the mapping restrictions of the one or more LCHs (e.g., reserving resources for the one or more LCHs that may otherwise not be available and/or reserved).

In some scenarios, the UE may map one or more first LCHs with important PDU sets and/or packets in the transmit buffer to resources indicated by the UL grant before mapping resources to one or more second LCHs. For example, the one or more second LCHs may not have one or more important PDU sets and/or packets in the transmit buffer, and may not be mapped to the resources indicated by the UL grant until the one or more first LCHs are mapped to respective resources. In some scenarios, the one or more second LCHs are mapped to the resources not mapped to the one or more first LCHs (e.g., the one or more second LCHs are mapped to remaining resources). In some scenarios, the UE employs one or more of the LCH configuration changes and/or mapping restrictions described above (e.g., described with reference to blocks 410-450) in some combination. In some scenarios, when a PSI-based discarding mechanism of a DRB associated with one or more LCHs is deactivated, the UE uses a default LCP procedure and/or prioritization, independently of one or more operations described with reference to blocks 410-450.

In some scenarios, a plurality of LCHs have one or more important PDU sets and/or packets in the transmit buffer. In such scenarios, the UE may determine the buffer size, the buffer delay, the relative proportion of important PDU sets and/or packets to the overall number of PDU sets and/or packets associated with a LCH, and/or some combination thereof. Based the results of such a determination, the UE may prioritize and/or de-prioritize particular LCHs, and/or PDU sets and/or packets associated with respective levels of importance.

FIG. 5 is a diagram of an example process 500 for initiating status reporting and/or transmitting a status request according to one or more implementations described herein. In some scenarios, the UE may detect a trigger associated with a mechanism for requesting an uplink grant (block 510). In some scenarios, the trigger may be associated with a scheduling request (SR), a buffer status report (BSR), and/or a delay status report (DSR). For example, the UE may have data arrived at a buffer associated with one or more LCHs, and in response, may trigger a SR.

In some scenarios, the UE determines the presence or absence of one or more important PDU sets and/or packets in the buffer of one or more LCHs (block 520). For example, the UE determines that there are not one or more PDU sets and/or packets associated with a first level of importance (e.g., corresponding to a PSI level less than a PSI threshold) (block 520—NO). In response, the UE may forgo transmission of the SR, BSR, and/or DSR (block 530). Thus, the UE may reduce the time and resources otherwise required to generate and/or transmit the SR, BSR, and/or DSR to the base station.

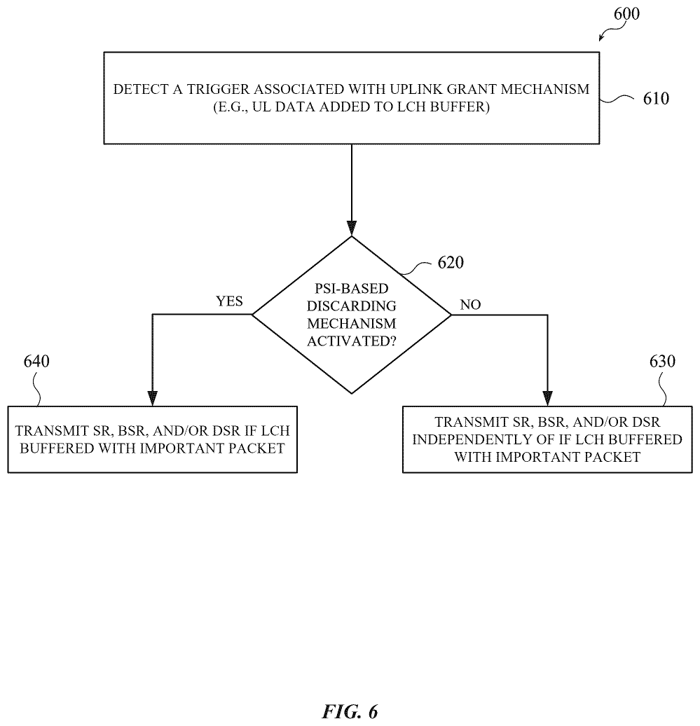

In some scenarios, the UE determines that one or more important PDU sets and/or packets are buffered in the one or more LCHs (block 520—YES). In response, the UE may transmit the SR, BSR, and/or DSR (block 540). It may be appreciated that the process 500 may in some scenarios not be a default process that informs the transmitting—or forgoing of the transmitting—of the SR, BSR, and/or DSR. For example, as described with reference to FIG. 6, the process described with reference to process 500 may be initiated when a PSI-based discarding mechanism is activated.

FIG. 6 is a diagram of an example process 600 for initiating status reporting and/or transmitting a status request according to one or more implementations described herein. In some scenarios, the UE may detect a trigger associated with a mechanism for requesting an uplink grant (block 610). In some scenarios, the trigger may be associated with a scheduling request (SR), a buffer status report (BSR), and/or a delay status report (DSR). For example, the UE may have data arrive at a buffer associated with one or more LCHs, and in response, may trigger a SR.

In some scenarios, the UE determines whether a PSI-based discarding mechanism associated with one or more DRBs that correspond to the one or more LCHs are activated. In some scenarios, the UE may determine that the PSI-based discarding mechanism is not activated (block 620—NO). In response the UE may generate and transmit a SR, BSR, and/or DSR in accordance with legacy procedures, such as regardless of whether the LCH is buffered with one or more important packets (block 630).

In some scenarios, the UE may determine that the PSI-based discarding mechanism associated with the one or more DRBs is activated (block 620—YES). In response, the UE may generate and/or transmit a SR, BSR, and/or DSR when a LCH is buffered with an important packet. As an example, the UE may generate and/or transmit the SR, BSR, and/or DSR when a PSI-based discarding mechanism is activated and the LCH is buffered with an important packet, as described with reference to process 500. As another example, when the PSI-based discarding mechanism is activated, and a respective LCH is not buffered with an important packet, the UE may forgo generating and/or transmitting of the SR, BSR, and/or DSR as described with reference to process 500.

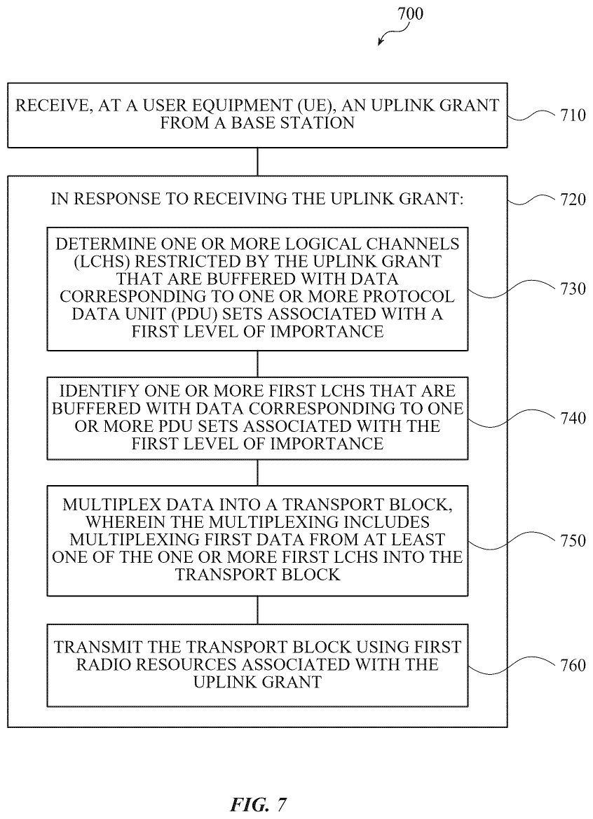

FIG. 7 is a diagram of a process 700 for transmitting PDUs associated with a first level of importance using resources indicated by an uplink grant according to one or more implementations described herein. In some scenarios, user equipment (UE) may comprise, memory, and one or more processors configured to, when executing instructions stored in the memory, cause the UE to receive (710), at a user equipment (UE), an uplink grant from a base station. In some scenarios, the one or more processors may be configured to, when executing instructions stored in the memory, cause the UE to, in response to receiving the uplink grant (720), determine (730) one or more logical channels (LCHs) restricted by the uplink grant that are buffered with data corresponding to one or more protocol data unit (PDU) sets associated with a first level of importance. In some scenarios, the one or more processors may be configured to, when executing instructions stored in the memory, cause the UE to, identify (740) one or more first LCHs that are buffered with data corresponding to one or more PDU sets associated with the first level of importance. In some scenarios, the one or more processors may be configured to, when executing instructions stored in the memory, cause the UE to, multiplex (750) data into a transport block, wherein the multiplexing includes multiplexing first data from at least one of the one or more first LCHs into the transport block. In some scenarios, the one or more processors may be configured to, when executing instructions stored in the memory, cause the UE to, transmit (760) the transport block using first radio resources associated with the uplink grant.

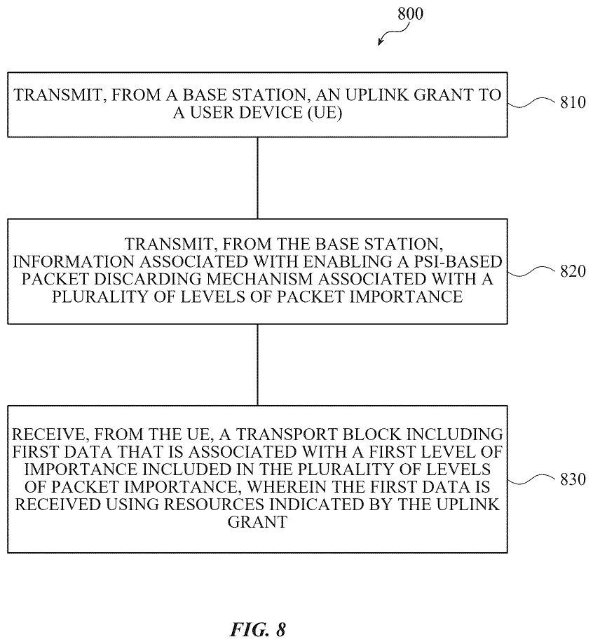

FIG. 8 is a diagram of a process 800 for transmitting an uplink grant to a UE associated with a PSI-based discarding mechanism according to one or more implementations described herein. In some scenarios, a base station (BS) may comprise memory, and one or more processors configured to, when executing instructions stored in the memory, cause the BS to receive transmit (810), from a base station, an uplink grant to a user device (UE). In some scenarios, the one or more processors may be configured to, when executing instructions stored in the memory, cause the UE to, transmit (820), from the base station, information associated with enabling a PSI-based discarding mechanism associated with a plurality of levels of packet importance. In some scenarios, the one or more processors may be configured to, when executing instructions stored in the memory, cause the UE to, receive (830), from the UE, a transport block including first data that is associated with a first level of importance included in the plurality of levels of packet importance, wherein the first data is received using resources indicated by the uplink grant.

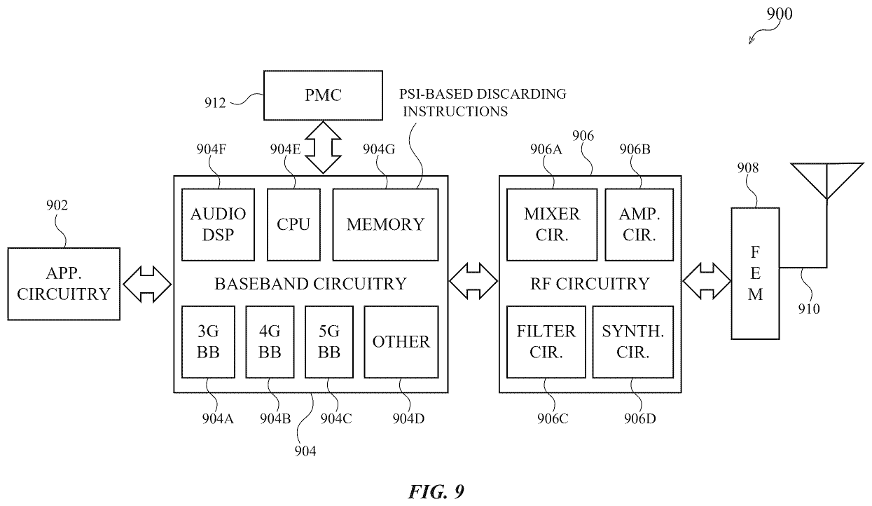

FIG. 9 is a diagram of an example of components of a device according to one or more implementations described herein. In some implementations, the device 900 can include application circuitry 902, baseband circuitry 904, RF circuitry 906, front-end module (FEM) circuitry 908, one or more antennas 910, and power management circuitry (PMC) 912 coupled together at least as shown. The components of the illustrated device 900 can be included in a UE or a RAN node. In some implementations, the device 900 can include fewer elements (e.g., a RAN node may not utilize application circuitry 902, and instead include a processor/controller to process IP data received from a CN or an Evolved Packet Core (EPC)). In some implementations, the device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for Cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process IP data packets received from an EPC.

The baseband circuitry 904 can include circuitry such as, but not limited to, one or more single-core or multi-core processors. The baseband circuitry 904 can include one or more baseband processors or control logic to process baseband signals received from a receive signal path of the RF circuitry 906 and to generate baseband signals for a transmit signal path of the RF circuitry 906. Baseband circuity 904 can interface with the application circuitry 902 for generation and processing of the baseband signals and for controlling operations of the RF circuitry 906. For example, in some implementations, the baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, etc.). The baseband circuitry 904 (e.g., one or more of baseband processors 904A-D) can handle various radio control functions that enable communication with one or more radio networks via the RF circuitry 906. In other implementations, some or all of the functionality of baseband processors 904A-D can be included in modules stored in the memory 904G and executed via a Central Processing Unit (CPU) 904E. The radio control functions can include, but are not limited to, signal modulation/demodulation, encoding/decoding, radio frequency shifting, etc. In some implementations, modulation/demodulation circuitry of the baseband circuitry 904 can include Fast-Fourier Transform (FFT), precoding, or constellation mapping/de-mapping functionality. In some implementations, encoding/decoding circuitry of the baseband circuitry 904 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 904G may receive and store one or more configurations, instructions, and/or other types of information to enable multiplexing of data in accordance with an uplink grant associated with a PSI-based discarding mechanisms. The uplink grant may be reserved and/or restricted for use by one or more LCHs that are buffered with data associated with a level of importance. The uplink grant may improve the prioritization, and thereby improve the likelihood the data associated with the level of importance is not discarded before transmission to a base station. These and many other features and examples are described herein and may be enabled by the configurations, instructions, and/or other types of information stored by memory 904G.

In some implementations, the baseband circuitry 904 can include one or more audio digital signal processor(s) (DSP) 904F. The audio DSPs 904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, the RF circuitry 906 can include switches, filters, amplifiers, etc. to facilitate the communication with the wireless network. RF circuitry 906 can include a receive signal path which can include circuitry to down-convert RF signals received from the FEM circuitry 908 and provide baseband signals to the baseband circuitry 904. RF circuitry 906 can also include a transmit signal path which can include circuitry to up-convert baseband signals provided by the baseband circuitry 904 and provide RF output signals to the FEM circuitry 908 for transmission.

In some implementations, the receive signal path of the RF circuitry 906 can include mixer circuitry 906A, amplifier circuitry 906B and filter circuitry 906C. In some implementations, the transmit signal path of the RF circuitry 906 can include filter circuitry 906C and mixer circuitry 906A. RF circuitry 906 can also include synthesizer circuitry 906D for synthesizing a frequency for use by the mixer circuitry 906A of the receive signal path and the transmit signal path. In some implementations, the mixer circuitry 906A of the receive signal path can be configured to down-convert RF signals received from the FEM circuitry 908 based on the synthesized frequency provided by synthesizer circuitry 906D. The amplifier circuitry 906B can be configured to amplify the down-converted signals and the filter circuitry 906C can be a low-pass filter (LPF) or band-pass filter (BPF) configured to remove unwanted signals from the down-converted signals to generate output baseband signals. Output baseband signals can be provided to the baseband circuitry 904 for further processing. In some implementations, the output baseband signals can be zero-frequency baseband signals, although this is not a requirement. In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 908. The baseband signals can be provided by the baseband circuitry 904 and can be filtered by filter circuitry 906C.

In some implementations, the mixer circuitry 906A of the receive signal path and the mixer circuitry 906A of the transmit signal path can include two or more mixers and can be arranged for quadrature down conversion and up conversion, respectively. In some implementations, the mixer circuitry 906A of the receive signal path and the mixer circuitry 906A of the transmit signal path can include two or more mixers and can be arranged for image rejection (e.g., Hartley image rejection). In some implementations, the mixer circuitry 906A of the receive signal path and the mixer circuitry 1406A can be arranged for direct down conversion and direct up conversion, respectively. In some implementations, the mixer circuitry 906A of the receive signal path and the mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 906 can include analog-to-digital converter (ADC) and digital-to-analog converter (DAC) circuitry and the baseband circuitry 904 can include a digital baseband interface to communicate with the RF circuitry 906.

In some dual-mode implementations, a separate radio IC circuitry can be provided for processing signals for each spectrum, although the scope of the implementations is not limited in this respect.

In some implementations, the synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

The synthesizer circuitry 906D can be configured to synthesize an output frequency for use by the mixer circuitry 906A of the RF circuitry 906 based on a frequency input and a divider control input. In some implementations, the synthesizer circuitry 906D can be a fractional N/N+1 synthesizer.

In some implementations, frequency input can be provided by a voltage-controlled oscillator (VCO), although that is not a requirement. Divider control input can be provided by either the baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of the RF circuitry 906 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 906 can include an IQ/polar converter.

FEM circuitry 908 can include a receive signal path which can include circuitry configured to operate on RF signals received from one or more antennas 910, amplify the received signals and provide the amplified versions of the received signals to the RF circuitry 906 for further processing. FEM circuitry 908 can also include a transmit signal path which can include circuitry configured to amplify signals for transmission provided by the RF circuitry 906 for transmission by one or more of the one or more antennas 910. In various implementations, the amplification through the transmit or receive signal paths can be done solely in the RF circuitry 906, solely in the FEM circuitry 908, or in both the RF circuitry 906 and the FEM circuitry 908.

In some implementations, the FEM circuitry 908 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 908 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, the PMC 912 can control power-source selection, voltage scaling, battery charging, or DC-to-DC conversion. The PMC 912 can often be included when the device 900 is capable of being powered by a battery, for example, when the device is included in a UE. The PMC 912 can increase the power conversion efficiency while providing desirable implementation size and heat dissipation characteristics.

While FIG. 9 shows the PMC 912 coupled only with the baseband circuitry 904. However, in other implementations, the PMC 912 may be additionally or alternatively coupled with, and perform similar power management operations for, other components such as, but not limited to, application circuitry 902, RF circuitry 906, or FEM circuitry 908.

In some implementations, the PMC 912 can control, or otherwise be part of, various power saving mechanisms of the device 900. For example, if the device 900 is in an RRC_Connected state, where it is still connected to the RAN node as it expects to receive traffic shortly, then it can enter a state known as discontinuous reception mode (DRX) after a period of inactivity. During this state, the device 900 can power down for brief intervals of time and thus save power.

If there is no data traffic activity for an extended period, then the device 900 can transition off to an RRC_Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 902 and processors of the baseband circuitry 904 can be used to execute elements of one or more instances of a protocol stack. For example, processors of the baseband circuitry 904, alone or in combination, can be used execute Layer 3, Layer 2, or Layer 1 functionality, while processors of the baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

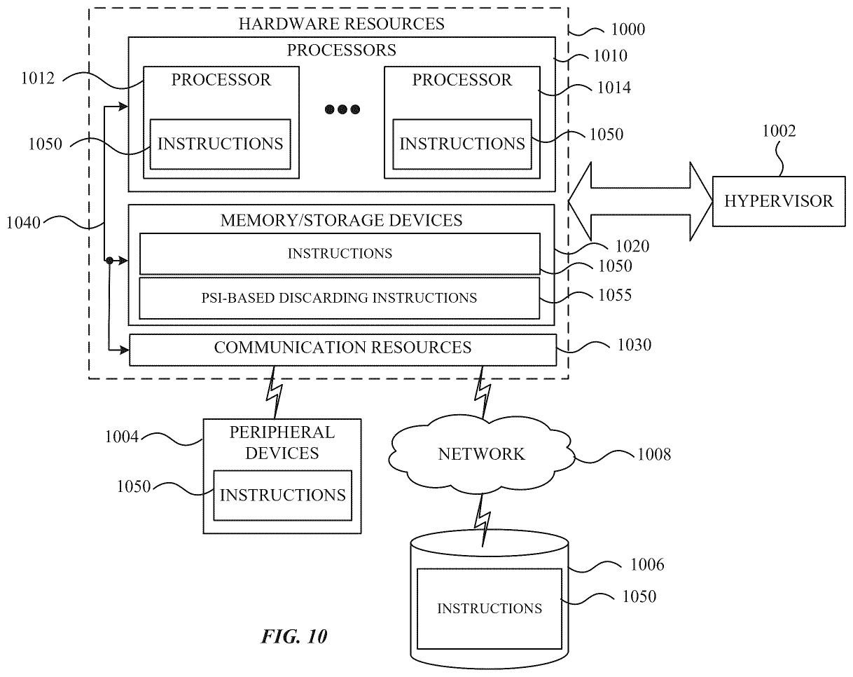

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For implementations where node virtualization (e.g., NFV) is utilized, a hypervisor may be executed to provide an execution environment for one or more network slices/sub-slices to utilize the hardware resources 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1014.

The memory/storage devices 1020 may include main memory, disk storage, or any suitable combination thereof. The memory/storage devices 1020 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1020 may receive and store one or more configurations, instructions, and/or other types of information 1055 to enable multiplexing of data in accordance with an uplink grant associated with a PSI-based discarding mechanisms. The uplink grant may be reserved and/or restricted for use by one or more LCHs that are buffered with data associated with a level of importance. The uplink grant may improve the prioritization, and thereby improve the likelihood the data associated with the level of importance is not discarded before transmission to a base station. These and many other features and examples are described herein and may be enabled by the configurations, instructions, and/or other types of information stored by memory/storage devices 1020.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a universal serial bus (USB)), cellular communication components, NFC components, Bluetooth® components (e.g., Bluetooth® low energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise memory, and one or more processors configured to, when executing instructions stored in the memory, cause the UE to receive, at a user equipment (UE), an uplink grant from a base station, and cause the UE to, in response to receiving the uplink grant, determine one or more logical channels (LCHs) restricted by the uplink grant that are buffered with data corresponding to one or more protocol data unit (PDU) sets associated with a first level of importance.

In example 2, which may also include one or more of the examples described herein, the one or more processors are further configured to cause the UE to, in response to receiving the uplink grant, determine a logical channel prioritization (LCP), wherein the one or more first LCHs that are buffered with data corresponding to the one or more PDU sets associated with the first level of importance are identified when the LCP is determined.

In example 3, which may also include one or more of the examples described herein, the one or more first LCHs that are buffered with data corresponding to the one or more PDU sets associated with the first level of importance are associated with an activated PSI-based packet discarding mechanism, wherein the PSI-based packet discarding mechanism is based upon a PDU set importance (PSI) level.

In example 4, which may also include one or more of the examples described herein, data included in the transport block does not include data multiplexed from one or more second LCHs, different from the one or more first LCHs, that are associated with a second level of importance, different from the first level of importance, and one or more data radio bearers (DRBs) associated with the one or more first LCHs are associated with an activated PSI-based packet discarding mechanism.

In example 5, which may also include one or more of the examples described herein, data included in the transport block does not include data multiplexed from one or more LCHs that are associated with a second level of importance, different from the first level of importance, and one or more data radio bearers (DRBs) associated with the at least one of the one or more first LCHs are associated with a deactivated PSI-based packet discarding mechanism.

In example 6, which may also include one or more of the examples described herein, the multiplexing of data into the transport block includes, when a data radio bearer (DRB) associated with the identified one or more first LCHs is associated with an activated PSI-based discarding mechanism, multiplexing the first data to occupy a first portion of the transport block, and after multiplexing the first data into the transport block, multiplexing second data from the one or more second LCHs to occupy a second portion of the transport block, wherein the second portion corresponds to a portion of the transport block available after multiplexing the first data.

In example 7, which may also include one or more of the examples described herein, the multiplexing of data into the transport block includes multiplexing the first data from one or more first LCHs to occupy a first portion of the transport block, and multiplexing second data from one or more second LCHs to occupy a second portion of the transport block, wherein the second portion corresponds to a portion of the transport block available after multiplexing the first data.

In example 8, which may also include one or more of the examples described herein, the one or more processors are further configured to cause the UE to determine a logical channel prioritization (LCP), and in response to determining the LCP, modify one or more of a first LCH priority, first prioritized bit rate, and a first set of LCH mapping rules that are associated with one or more second LCHs, different from the identified one or more first LCHs, wherein the one or more second LCHs are buffered with data corresponding to one or more PDU sets associated with a second level of importance, different from the first level of importance.

In example 9, which may also include one or more of the examples described herein, the one or more processors are further configured to cause the UE to determine a logical channel prioritization (LCP), and in response to determining the LCP, modify one or more of a first LCH priority, first prioritized bit rate, and a first set of LCH mapping rules associated with the identified one or more first LCHs.

In example 10, which may also include one or more of the examples described herein, the one or more processors are further configured to cause the UE to determine a logical channel prioritization (LCP), and in response to determining the LCP, after multiplexing the first data from the at least one or more of the first LCHs into the transport block, and when a portion of the transport block is unoccupied by the first data, multiplex second data, different from the first data, associated with one or more LCHs that are buffered with data corresponding to one or more PDU sets associated with a second level of importance, different from the first level of importance.

In example 11, which may also include one or more of the examples described herein, the one or more processors are further configured to cause the UE to when one or more criteria are satisfied, including a criterion that is satisfied when a PSI-based packet discarding mechanism is activated for a DRB corresponding to the identified one or more first LCHs, transmit first information associated with a first status report or request of the UE to the base station, and when the one or more criteria are not satisfied, forgo the transmitting of the first information associated with the first status report or request of the UE. In example 12, which may also include one or more of the examples described herein, the first information includes one or more of: a scheduling request (SR), a buffer status report (BSR), and a delay status report (DSR). In example 13, which may also include one or more of the examples described herein, the one or more criteria include one or more of group including: a first criterion that is satisfied when a PSI-based packet discarding mechanism is activated and a second criterion that is satisfied when the one or more first LCHs are buffered with data associated with the first level of importance.

In example 14, which may also include one or more of the examples described herein, a base station (BS) may comprise memory, and one or more processors configured to, when executing instructions stored in the memory, cause the BS to transmit, from a base station, an uplink grant to a user device (UE), transmit, from the base station, information associated with activating a PSI-based packet discarding mechanism associated with a plurality of levels of packet importance, and receive, from the UE, a transport block including first data that is associated with a first level of importance included in the plurality of levels of packet importance, wherein the first data is received using resources indicated by the uplink grant.

In example 15, which may also include one or more of the examples described herein, the resources indicated by the uplink grant are restricted for to one or more logical channels (LCHs) that are buffered with data corresponding to one or more protocol data unit (PDU) sets associated with a first level of importance in a buffer of the UE.

In example 16, which may also include one or more of the examples described herein, the uplink grant includes an indication that the resources indicated by the uplink grant are restricted to one or more LCHs having a data resource bearer (DRB) associated with the activated PSI-based packet discarding mechanism.

In example 17, which may also include one or more of the examples described herein, the uplink grant includes an indication that the resources indicated by the uplink grant are available to one or more LCHs independently of whether a data resource bearer (DRB) associated with the one or more LCHs are associated with the activated PSI-based packet discarding mechanism.

In example 18, which may also include one or more of the examples described herein, the uplink grant includes an indication that the resources indicated by the uplink grant are available to one or more first LCHs associated with a second level of importance when the one or more PDU sets associated with the first level of importance are multiplexed into the transport block received from the UE, wherein the one or more PDU sets are associated with a DRB having an PSI-based packet discarding mechanism.

In example 19, which may also include one or more of the examples described herein, the uplink grant includes an indication that the resources indicated by the uplink grant are available to one or more first LCHs associated with a second level of importance when the one or more PDU sets associated with the first level of importance are multiplexed into the transport block received from the UE, wherein multiplexing of the one or more PDU sets is performed independently of whether a DRB associated with the one or more PDU sets has an activated PSI-based packet discarding mechanism.

In example 20, which may also include one or more of the examples described herein, the one or more processors are further configured to cause the BS to receive, from the UE, a status report or request including second information, wherein the second information is based upon a presence or absence of a PDU set associated with the first level of importance in a buffer of the UE.

In example 21, which may also include one or more of the examples described herein, the information associated with enabling a PSI-based packet discarding mechanism deactivates the PSI-based packet discarding mechanism, and the one or more processors are further configured to cause the BS to receive, from the UE, a status report or request including second information, wherein the second information is based upon a presence or absence of a PDU set associated with a second level of importance in a buffer of the UE, different from the first level of importance.

In example 22, which may also include one or more of the examples described herein, a baseband processor, which when executing one or more instructions, instructs a UE to receive, at a user equipment (UE), an uplink grant from a base station, and in response to receiving the uplink grant, determine one or more logical channels (LCHs) restricted by the uplink grant that are buffered with data corresponding to one or more protocol data unit (PDU) sets associated with a first level of importance, identify one or more first LCHs that are buffered with data corresponding to one or more PDU sets associated with the first level of importance, multiplex data into a transport block, wherein the multiplexing includes multiplexing first data from at least one of the one or more first LCHs into the transport block, and transmit the transport block using first radio resources associated with the uplink grant.

In example 23, which may also include one or more of the examples described herein, a baseband processor, which when executing one or more instructions, instructs a transceiver to, transmit, from a base station, an uplink grant to a user device (UE), transmit, from the base station, information associated with activating a PSI-based packet discarding mechanism associated with a plurality of levels of packet importance, and receive, from the UE, a transport block including first data that is associated with a first level of importance included in the plurality of levels of packet importance, wherein the first data is received using resources indicated by the uplink grant.

In example 24, which may also include one or more of the examples described herein, a baseband processor, is configured to when executing one or more instructions, cause a UE to perform according to one or more of the examples described herein. In example 25, which may also include one or more examples described herein, a method, performed by a UE, according to one or more examples described herein. In example 26, which may also include one or more examples described herein, a computer-readable medium, storing instructions is configured to cause one or more processors to perform according to one or more of the examples described herein. In example 27, which may also include one or more of the examples described herein, a baseband processor, is configured to when executing one or more instructions cause a base station to perform according to one or more of the examples described herein. In example 28, which may also include one or more of the examples described herein, a method, performed by a base station according to one or more of the examples described herein. In example 29, which may also include one or more of the examples described herein, a computer-readable medium, storing instructions configured to cause one or more processors to perform according to one or more of the examples described herein.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE) comprising:
memory; and
one or more processors configured to, when executing instructions stored in the memory, cause the UE to:
receive, at a user equipment (UE), an uplink grant from a base station;
in response to receiving the uplink grant:
determine, based on the uplink grant, one or more logical channels (LCHs) reserved for data corresponding to one or more protocol data unit (PDU) sets associated with a first level of importance; and
identify one or more first LCHs that are buffered with data corresponding to one or more PDU sets associated with the first level of importance;
multiplex data into a transport block, wherein the multiplexing includes multiplexing first buffered data from at least one of the first LCHs into the transport block; and
transmit the transport block using first radio resources associated with the uplink grant using the at least one of the first LCHs.

2. The UE of claim 1, wherein the one or more processors are further configured to cause the UE to:
in response to receiving the uplink grant, determine a logical channel prioritization (LCP), wherein the one or more first LCHs are identified when the LCP is determined.

3. The UE of claim 1, wherein the one or more first LCHs are associated with an activated PSI-based packet discarding mechanism, wherein the PSI-based packet discarding mechanism is based upon a PDU set importance (PSI) level.

4. The UE of claim 1, wherein:
data included in the transport block does not include data multiplexed from one or more second LCHs, different from the one or more first LCHs, that are associated with a second level of importance, different from the first level of importance, and
one or more data radio bearers (DRBs) associated with the one or more first LCHs are associated with an activated PSI-based packet discarding mechanism.

5. The UE of claim 1, wherein:
data included in the transport block does not include data multiplexed from one or more second LCHs that are associated with a second level of importance, different from the first level of importance, and
one or more data radio bearers (DRBs) associated with the at least one of the one or more first LCHs are associated with a deactivated PSI-based packet discarding mechanism.

6. The UE of claim 1, wherein the multiplexing of data into the transport block includes:
when a data radio bearer (DRB) associated with the identified one or more first LCHs is associated with an activated PSI-based discarding mechanism, multiplexing the first buffered data to occupy a first portion of the transport block, and
after multiplexing the first buffered data into the transport block, multiplexing second buffered data from one or more second LCHs to occupy a second portion of the transport block, wherein the second portion corresponds to a portion of the transport block available after multiplexing the first buffered data.

7. The UE of claim 1, wherein the multiplexing of data into the transport block includes:
multiplexing the first buffered data from the one or more first LCHs to occupy a first portion of the transport block, and
multiplexing second buffered data from one or more second LCHs to occupy a second portion of the transport block, wherein the second portion corresponds to a portion of the transport block available after multiplexing the first buffered data.

8. The UE of claim 1, wherein the one or more processors are further configured to cause the UE to:
determine a logical channel prioritization (LCP); and
in response to determining the LCP, modify one or more of a first LCH priority, first prioritized bit rate, and a first set of LCH mapping rules that are associated with one or more second LCHs, different from the identified one or more first LCHs, wherein the one or more second LCHs are buffered with data corresponding to one or more PDU sets associated with a second level of importance, different from the first level of importance.

9. The UE of claim 1, wherein the one or more processors are further configured to cause the UE to:
determine a logical channel prioritization (LCP); and
in response to determining the LCP, modify one or more of a first LCH priority, first prioritized bit rate, and a first set of LCH mapping rules associated with the identified one or more first LCHs.

10. The UE of claim 1, wherein the one or more processors are further configured to cause the UE to:
determine a logical channel prioritization (LCP); and
in response to determining the LCP, after multiplexing the first buffered data from the at least one or more of the first LCHs into the transport block, and when a portion of the transport block is unoccupied by the first buffered data, multiplex second buffered data, different from the first buffered data, associated with one or more LCHs that are buffered with data corresponding to one or more PDU sets associated with a second level of importance, different from the first level of importance.

11. The UE of claim 1, wherein the one or more processors are further configured to cause the UE to:
when one or more criteria are satisfied, including a criterion that is satisfied when a PSI- based packet discarding mechanism is activated for a DRB corresponding to the identified one or more first LCHs, transmit first information associated with a first status report or request of the UE to the base station; and
when the one or more criteria are not satisfied, forgo the transmitting of the first information associated with the first status report or request of the UE.

12. A base station (BS) comprising:
memory; and
one or more processors configured to, when executing instructions stored in the memory, cause the BS to:
transmit, from a base station, an uplink grant to a user device (UE);
transmit, from the base station, information associated with activating a PSI-based packet discarding mechanism associated with a plurality of levels of packet importance; and
receive, from the UE, a transport block including first buffered data that is associated with a first level of importance included in the plurality of levels of packet importance, wherein the first buffered data is received using resources indicated by the uplink grant.

13. The BS of claim 12, wherein the resources indicated by the uplink grant are restricted for to one or more logical channels (LCHs) that are buffered with data corresponding to one or more protocol data unit (PDU) sets associated with the first level of importance in a buffer of the UE.

14. The BS of claim 12, wherein the uplink grant includes an indication that the resources indicated by the uplink grant are restricted to one or more LCHs having a data resource bearer (DRB) associated with the activated PSI-based packet discarding mechanism.

15. The BS of claim 12, wherein the uplink grant includes an indication that the resources indicated by the uplink grant are available to one or more LCHs independently of whether a data resource bearer (DRB) associated with the one or more LCHs are associated with the activated PSI-based packet discarding mechanism.

16. The BS of claim 12, wherein the uplink grant includes an indication that the resources indicated by the uplink grant are available to one or more first LCHs associated with a second level of importance when the one or more PDU sets associated with the first level of importance are multiplexed into the transport block received from the UE, wherein the one or more PDU sets are associated with a DRB having an PSI-based packet discarding mechanism.

17. The BS of claim 12, wherein the uplink grant includes an indication that the resources indicated by the uplink grant are available to one or more first LCHs associated with a second level of importance when the one or more PDU sets associated with the first level of importance are multiplexed into the transport block received from the UE, wherein multiplexing of the one or more PDU sets is performed independently of whether a DRB associated with the one or more PDU sets has an activated PSI-based packet discarding mechanism.

18. The BS of claim 12, wherein the one or more processors are further configured to cause the BS to:
receive, from the UE, a status report or request including second information, wherein the second information is based upon a presence or absence of a PDU set associated with the first level of importance in a buffer of the UE.

19. The BS of claim 12, wherein the information associated with enabling a PSI-based packet discarding mechanism deactivates the PSI-based packet discarding mechanism, and the one or more processors are further configured to cause the BS to:
receive, from the UE, a status report or request including second information, wherein the second information is based upon a presence or absence of a PDU set associated with a second level of importance in a buffer of the UE, different from the first level of importance.

20. A baseband circuitry, which when executing one or more instructions, causes one or more processors to:
receive, at a user equipment (UE), an uplink grant from a base station;
in response to receiving the uplink grant:
determine, based on the uplink grant, one or more logical channels (LCHs) reserved for data corresponding to one or more protocol data unit (PDU) sets associated with a first level of importance; and
identify one or more first LCHs that are buffered with data corresponding to one or more PDU sets associated with the first level of importance;
multiplex data into a transport block, wherein the multiplexing includes multiplexing first buffered data from at least one of the first LCHs into the transport block; and
transmit the transport block using first radio resources associated with the uplink grant using the at least one of the first LCHs.
